(19) United States
(12) Patent Application Publication
(10) Pub. No.: US 2007/0269571 A1
(43) Pub. Date: Nov. 22, 2007

(54) Composition for Soybean Protein-Processed Food, Paste for Meat-Containing or Meat-Not-Containing Processed Food, Dried Meat-Like Food

(75) Inventors: Michihide Akita, Yonago-shi (JP); Tetsuko Okada, Fujisakicho (JP)

Correspondence Address: OSTROLENK FABER GERB & SOFFEN, 1180 AVENUE OF THE AMERICAS, NEW YORK, NY, 100368403, US

(73) Assignee: STC SYSTEM JAPAN CO., LTD., Tottori (JP)

(21) Appl. No.: 11/571,512

(22) PCT Filed: Jul. 27, 2005
(86) PCT No.: PCT/JP05/13709

§ 371 Date: Mar. 29, 2007

(51) Int. Cl. A23J 1/14

(52) U.S. Cl. 426/549; 426/573; 426/575; 426/606; 426/650; 426/656

(57) ABSTRACT

A processed food containing as a main component a soybean protein having a biological controlling function or physiological function has the mouth sensation, texture, taste, color, appearance and fragrance which resemble those of beef, pork or chicken which is a main component of real meat processed-food and contributes to prevent a life-style related disease by using as a substitute for a meat processed-food to decrease the amount of the ingestion of meat. A composition for preparing soybean protein-processed food comprises 5 to 10% of soybean protein, 5 to 8% of gelling agent, 0.1 to 0.3%/o of coagulating agent and 70 to 90% of water on the basis of the total weight of the composition.

### BACKGROUND OF THE INVENTION

### Field of the Invention

The present invention relates to a composition for a soybean protein-processed food, a paste for a meat-containing or meat-not-containing processed-food and a pemmican-like food. More in detail, the present invention relates to a composition for a soybean protein-processed food, a paste for a meat-containing or meat-not-containing processed-food and a pemmican-like food, which contain a soybean protein as a main component and a dietary fiber-richly-containing food material as a gelling agent.

The composition for a soybean protein-processed food of the present invention in itself can be processed, per se, to prepare a hamburger steak, a croquette, a meatball, a meat-sauce, etc., which contain no meat. Alternatively, the composition for a soybean protein-processed food of the present invention can be used as a bulking agent or quality modifier for a meat processed-food such as a hamburger steak, a croquette, a meat-ball, a meat-sauce, etc.

The paste for a hamburger steak of the present invention can be processed in itself to prepare a hamburger steak, a croquette, a meatball, a meat-sauce, etc., which contain no meat. Alternatively, the paste for a hamburger steak of the present invention can be used as a bulking agent or quality modifier for a meat processed-food such as a hamburger steak, a croquette, a meat-ball, a meat-sauce, etc.

The term “paste for a meat-containing or meat-not-containing processed-food” herein used means that the composition for a soybean protein-processed food of the present invention comprising 5 to 10 wt % of soybean protein, 0.5 to 8wt % of gelling agent, 0.1 to 0.3 wt % of coagulating agent, 0.1 to 1 wt % of edible oils and fats and 85 to 90wt % of water is used as a bulking agent or quality modifier for preparing a usual meat processed-food such as a hamburger steak, a croquette, a meat-ball, a meat-sauce, etc. Further, the term “paste for a meat-containing or meat-not-containing processed-food” herein used means that the composition for a soybean protein-processed food of the present invention comprising 5 to 10 wt % of soybean protein, 0.5 to 8wt % of gelling agent, 0.1 to 0.3wt % of coagulating agent, 0.1 to 1 wt % of edible oils and fats and 85 to 90wt % of water can be processed in itself for preparation of a processed-food such as a hamburger steak, a croquette, a meat-ball, a meat-sauce, etc. which do not contain meat.

In the following descriptions, there is a case where a hamburger steak is adopted as a representative for a meat processed-food such as a hamburger steak, a croquette, a meatball, a meat-sauce, etc. However, the present invention is not limited to a hamburger steak, a croquette, a meat-ball, meat sauce, etc., but applied to another meat-processed food such as fried chicken, grilled chicken, grilled meat, etc.

The term “dried meat-like food” herein used means a ham-like or bacon-like food containing no pork which is prepared by processing the paste for a meat-containing or meat-not-containing processed-food of the present invention, or means a “pemmican”-like food containing no beef which is prepared by processing the composition for a soybean protein-processed food of the present invention. Such terms are used in order to avoid confusion with genuine ham, bacon or pemmican. Pemmican is a kind of dried beef, which has been bequeathed by Native Americans d is a called generally as “beef jerky”. Since, however, “beef jerky” is a registered trademark, pemmican is usually used in the filed of food.

A Japanese food life has been called as “Japanese-type eating habit” which is composed of rice as the chief staple of the diet, and various kinds of side dishes such as fish and shellfish, seaweed, vegetables, soybean-processed foods, etc. The Japanese food life has been also called as “grain-properly consumption-balance-type food life” which means that various kinds of foods are consumed in balance.

Japan is a prominent nation of longevity. The major factor is said to be the proper “PFC-ratio” by such “Japanese-type eating habit” The PFC-ratio is an indicator presented in “Dietary Goals for the United States” in USA 1977. The proper FEC-ratio is defined to be that Protein is 12 to 13%, Fat is 20 to 30% and Carbohydrate is 68 to 57.

However, since the latter half of '60, various kinds of food businesses and eating-out industries have standardized or popularized a Western-style menu of a meat-processed food such as a hamburger steak, a beefsteak, etc. Such a Western-style menu has been introduced into a daily life of home. Therefore, the Japanese ideal PFC-ratio has been changed with the increase in the consumption of animal protein, high-fatty foods, and simultaneously a life-style related disease (metabolic syndrome) such as obesity, hypertension, hyperlipemia, hyperglycemia, etc. has been increased.

The Nutrition Clinic attached to the Women's University of Nutrition or JMA (the Japan Medical Association) proposes it as a food capable of preventing a life-style related disease to reduce the amount of ingestion of animal fats and to increase the amount of ingestion of vegetable proteins and dietary fibers.

Accordingly, a food containing as a main component vegetable proteins having a biological adjusting function or physiological function the mouth sensation, texture, taste, color, appearance and fragrance of which resemble those of beef, pork, or chicken which is a main component of meat processed-food has been expected. Such a food is expected to be used as a substitute for a meat processed-food and to decrease the amount of the ingestion of meat. Further, such a food is expected to contribute to prevent a life-style related disease.

A food using as a main component a soybean curd (tofu) or bean-curd tofu refuse (okara) has been conventionally proposed. Literature No. 1 describes a method of preparing a food material comprising steps of; mixing powder of devil's tongue jelly with hot water to form a jelly; mixing the jelly with a raw egg and bean-curd tofu refuse to form a mixture; mixing the mixture with an alkaline solution prepared by dissolving calcium hydroxide in tepid water to solidify it; cutting it; and heating it to remove residual alkaline contents to impart meat-eating mouth sensation. The nomenclature in Latin of the term “devil's tongue jelly” is “Amorphophallus rivieri var. konjac”.

Literature No. 2 describes-a bean-curd tofu refuse (okara)-processed food prepared by dispersing a fine denatured egg yolk in the bean-curd tofu refuse (okara) to form a mixed product and by making it contain in a skin-like edible product.

Literature No. 3 describes a food containing a bean-curd tofu refuse (okara) and fish.

Literature No. 4 describes a processed food prepared by mixing a bean-curd tofu refuse (okara) or bean with devil's tongue jelly (konnyaku) to solidify.

By the way, there are various types of forms of soybean proteins other than soybean curd (tofu) such as soybean milk, dried soybean curd (tofu), soybean protein curd, powdered soybean protein, powdered concentrated soybean protein, spun fiber-like soybean protein, particle-like soybean protein, lump-like soybean protein, flake-like soybean protein, bar-like soybean protein, dice-like soybean protein, etc. However, the above-described prior arts limit a raw material as soybean protein to a bean-curd tofu refuse (okara). Therefore, the above-described prior arts have defects that the range of choice of the raw materials is narrow and forms of the final products are limited.

Objects of the above-described prior arts are improvement in meat-eating sensation or mouth sensation of bean-curd tofu refuse (okara). However, the above-described prior arts do not make examination on soybean protein from the viewpoint of nutritional science or physiology.

Literature No.1: Japanese Patent No. 349808

Literature No.2: Unexamined Patent Application, laying-open No. 4-200372

Literature No. 3: Unexamined Patent Application, laying-open No. 59-203463

Literature No. 3: Unexamined Patent Application, laying-open No. 10-52233

### DISCLOSURE OF INVENTION Problems to be solved by Invention

An object of the invention is to provide a processed food containing as a main component a vegetable protein having a biological adjusting function or physiological function, the mouth sensation, texture, taste, color, appearance and fragrance of which resemble those of beef, pork or chicken which is a main component of meat processed-food and to contribute to prevent a life-style related disease by using such a processed food as a substitute for a meat processed-food to decrease the amount of the ingestion of meat.

Another object of the invention is to expand the use of soybean protein by selecting soybean protein having the optimum form and properties for the kinds of final products of meat processed foods to make the mouth sensation, texture, taste, color, appearance and fragrance of the final products resemble those of meat-processed foods.

A further object of the invention is that a food material having a good compatibility with the soybean protein is added to a soybean protein to improve the inherent advantages of the soybean protein and the food material and improve the defects thereof, thereby making the texture of a final processed food resemble the texture of meat processed food.

Still a further object of the invention is to provide a soybean protein-processed food capable of being processed, per se, for a hamburger steak, a croquette, a meat-ball, a meat-sauce, etc., containing no meat or to provide a soybean protein-processed food capable of being used as a bulking agent or quality modifier for a meat processed-food such as a hamburger steak, a croquette, a meat-ball, a meat-sauce, etc.

An even further object of the invention is to provide a ham-like or bacon-like food containing no pork by processing the paste used for a meat-containing or meat-no-containing processed-food of the present invention or to provide a pemmican-like food containing no beef by processing the composition for a soybean protein-processed food of the present invention.

In surveying the method for solving the problems, the nutritional and physiological function of soybean protein which is a main component of the composition for soybean protein processed food of the present invention described below: In the specified researching theme “Systematic analysis and development of food function” continued for three years from 1984 to 1986 by the Ministry of Education and Science, the conception “functionality of food” was proposed. In this research, the functionalities of food were classified into; (1) nutritional function (primary function); (2) function in taste and sensation (secondary function); and (3) physiologically-controlling function (third function).

Since the starting of the specified theme researched by the Ministry of Education and Science, research has been made by Japanese universities, researching organizations attached to the Japanese government, private researching organizations, etc. As a result, many food components were found, which control a secretory system, nerve system, circulatory system, digestive system, immunological system and has an intestinal function controlling action, carcinogenicity prevention function, lipid metabolism improving function, antioxidation function, aging prevention function, etc. from vegetables, fruits, dairy products, seafood, etc. daily ingested.

In these results, functions and components of soybeans, which are directly related, the present invention is shown in Table-1 (“Function of foods-the present condition and future of its study” by Soichi Arai, 48, 645 to 652, 1997).

TABLE 1

| Biologically controlling | Nutrition (food containing the |
|---|---|
| function expected | nutrition) |
| Reinforcement of insulin | Glycinin (soybean) |
| function | |
| Estrogen function | Isoflavone (soybean) |
| Antihypertensive function, | Glycinin (soybean) |
| cholesterol lowering function | |
| Antithrombotic function | Peptide originating from |
| | glycinin (soybean) |

“The Conference on General Science and Technology” organized by the Japanese government in 2001 have pushed on with the research and development on functional food. The physiological functions, which were made clear by the research and development, are shown in Table-2.

TABLE 2

| | Functional agricultural products |
|---|---|
| Biological function | (nutrition) |
| Reinforcement of insulin | Soybean (protein, phospholipids) |
| function | |
| Estrogen function | Bean and pea |
| Antihypertensive function, | Soybean (peptide) |
| cholesterol lowering function | |
| Antithrombotic function | Soybean (Isoflavone) |

A system for “Specified Food for Health” was established in 1991 on the basis of the Nutrition Improvement Act. Specified foods for health authorized at the present and nutritional ingredients, which are related to the present invention, are shown 5 in Table-3.

TABLE 3

| Specified food for health | Related functional component |
|---|---|
| Intestine controlling food | Soybean oligosaccharide |
| Dietary fiber | Mannan |
| Cholesterol lowering food, | Soybean protein |
| cholesterol lowering food + | |
| Intestine controlling food | |
| Glycolipid metabolic | Soybean (Isoflavone) |
| activation | |

Conventionally, a soybean protein processed food such as soybean curd (tofu), fermented soybeans, etc has been called as “health food” which is only good for a body. However, as a result of scientific studies by a research organization attached to the Japanese government, it is proved that such a soybean protein processed food is excellent from the viewpoint of nutrimental function, biological adjusting function or physiological function.

By the way, various types of forms and properties for soybean proteins are now produced. Firstly, soybean milk can be produced as a first soybean protein by subjecting soybeans to solvent extraction to separate them into rind and soybean oil, pulverizing the residual skimmed soybeans under heating to prepare powdered skimmed soybeans, and removing fibrous non-soluble products. Alternatively, soybean milk can be produced as a first soybean protein by subjecting soybeans to solvent extraction to separate them into rind and soybean oil, boiling the residual skimmed soybeans to prepare a water solution containing swollen soybeans through water-extraction and removing fibrous non-soluble products.

Soybean proteins can be produced by sterilizing soybean milk under drying to prepare dried soybean milk.

Soybean protein curds can be produced by separating proteins from the soybean milk by acid.

Particle-like separated soybean proteins can be produced by sterilizing soybean protein curds, neutralizing them, and subjecting them to spray drying.

Soybean protein curds can be produced by washing the above-described skimmed soybeans with acid or alcohol.

Particle-like concentrated soybean proteins can be produced by sterilizing soybean protein curds, neutralizing them, and subjecting them to spray drying.

Soybean protein curds, particle-like separated soybean proteins, particle-like concentrated soybean proteins produces in such a manner as described above are processed by means of a single-screw extruder, nozzle spraying, or double-screw extruder to form spun fiber-like soybean proteins, structural fiber-like soybean proteins, particle-like soybean proteins, hunk-like soybean proteins, flake-like soybean proteins, bar-like soybean proteins, dice-like soybean proteins. Since proteins are denatured and enzymes such as trypsin-inhibiting enzyme, etc. are deactivated by virtue of high temperatures of an extruder, smell unique to soybeans is disappears.

Accordingly, the term “soybean protein” herein used includes soybean milk, dried soybean milk, soybean protein curds, particle-like separated soybean proteins, particle-like concentrated soybean proteins, spun fiber-like soybean proteins, structural fiber-like soybean proteins, particle-like soybean proteins, hunk-like soybean proteins, flake-like soybean proteins, bar-like soybean proteins, dice-like soybean proteins.

Such soybean proteins are different from each other in the contents of proteins, form, properties and functions for each of products'. Therefore, if the optimum soybean proteins are not selected in consideration of the kinds, form, properties, etc. of a final product, excellent mouth sensation, that is texture, taste, color, appearance and odor of a final product cannot be obtained.

For example, particle-like separated soybean proteins are produced by sterilizing soybean protein curds, neutralizing them, and subjecting them to spray drying. Particle-like separated soybean proteins are tasteless and odorless, and excellent in water-solubility, water-retention properties, integrity, emulsifying properties, gelling properties and bonding properties. By taking advantage of such properties, particle-like separated soybean proteins are used as a quality-reinforcing agent or stabilizing agent for deep-fried foods, deep-fried tofu, sausage, steamed fish-paste cake, etc.

Particle-like concentrated soybean proteins are dried structural soybean proteins and classified into beef-type, pork-type produced by sterilizing soybean protein curds, neutralizing them, 6 chicken-type, etc. depending on the size of particle and color. Since such particle-like concentrated soybean proteins have texture like meat, they are suitable for hamburger, meatball, Chinese dumplings stuffed with minced pork and vegetables, steamed dumplings with dough gathered at the top, etc.

Fiber-like soybean proteins are significantly excellent in mouth sensation (texture) and used for producing a meat-processed food, fish-processed food or seafood-processed food. Fiber-like soybean proteins are easy to be seasoned. Therefore, when they are processed, they cannot be distinguished from meat,

Hunk-like soybean proteins, flake-like soybean proteins, bar-like soybean proteins and dice-like soybean proteins are produced by two-screw extruder and have tissue like meat and excellent mouth sensation (texture).

Accordingly, when the composition for a soybean protein-processed food of the present invention, in itself, is processed to prepare a hamburger steak, a croquette, a meat-ball, a meat-sauce, etc. containing no meat or is used as a bulking agent or quality modifier for a meat processed-food such as a hamburger steak, a croquette, a meat-ball, a meat-sauce, etc., particle-like separated soybean proteins, fiber-like soybean proteins, hunk-like soybean proteins, flake-like soybean proteins, bar-like soybean proteins or dice-like soybean proteins is preferable used as a raw material, and particle-like separated soybean proteins or fiber-like soybean proteins are more preferably used, and fiber-like soybean proteins are most preferably used. Of course, soybean curd (tofu) or bean curd tofu refuse (okara) can be used according to the present invention.

The nutritional value of a meat not-containing hamburger steak in-processing the composition for a soybean protein-processed food of the present invention in itself is described below. That is to say, the nutritional value when a given amount of beef is substituted for soybean proteins is described below. Giving 45 g/day of proteins to a male adult 70 kg in weight carried out a test. When 100% of soybean proteins and 0% of meat were given, the nitrogen equilibrium (mgN/kg/day) was −2.3 and the digestion ratio was 96: When 75% of soybean proteins and 25% of meat were given, the nitrogen equilibrium (mgN/kg/day) was −3.2, and the digestion ratio was 99:

When 50% of soybean proteins and 50% of meat were given, the nitrogen equilibrium (mgN/kg/day) was −0.9 and the digestion ratio was 98: When 25% of soybean proteins and 75% of meat were given, the nitrogen equilibrium (mgN/kg/day) was −1.1 and the digestion ratio was 98:When 0% of soybean proteins and 100% of meat were given, the nitrogen equilibrium (mgN/kg/day) was −1.7 and the digestion ratio was 98. It is proved that nitrogen equilibrium (mgN/kg/day) and the digestion ratio do not change between soybean proteins and beef.

As described above, soybean proteins as a main component of the composition for a soybean protein-processed food of the present invention have excellent nutritional and physiological properties and can be sufficiently substituted for meat from the nutritional and physiological view points. However, soybean proteins have defects that viscoelasticity is low and have so-called “crumbled” or “dry and tasteless” mouth sensation.

Accordingly, a gelling agent is used as a second component of the composition for a soybean protein-processed food of the present invention. By gelling a water solution of soybean proteins as a main component of the composition for a soybean protein-processed food of the present invention, the elasticity and viscosity of the gelled soybean proteins are drastically increased; Newton's viscosity of the gelled soybean proteins changes to non-Newton's viscosity; the gelled soybean proteins have a yield point; and the gelled soybean proteins are easy to chew. While the “coagulating properties”, “viscosity”, “elasticity” and “stickiness” are important as texture profile of food; the viscosity and elasticity can be increased by gelling a water solution of soybean proteins as a main component of the composition for a soybean, thereby increasing easiness to chew. More concretely, the gelled soybean proteins are not too soft and not too hard, and have the improved elasticity and viscosity and chewy mouth sensation similar to that, which is obtained when chewing meat.

Examples of the gelling agent used in the present invention are; (1) a polysaccharide or lignin such as cellulose, hemicellulose, pectin, etc. which is a constituent of plant cell wall; (2) a water-soluble polysaccharide of plant gum (secretion of bark or fruit) or mucilage (intracellular reserve substance of seed, leaf or rhizome) such as gua gum, tamarind, etc. originating from a seed, or Glucomannan and etc. originating from a rhizome, or gum arabic, tragacanth gum, karaya gum, etc. originating from sap; (3) seaweed polysaccharide such as carrageenan, agar, alginic acid, etc.; (4) polysaccharide produced by microorganisms such as xanthine gum, Natade coco, etc.;(5) Difficult-to-digest starch, difficult-to-digest dextrin, difficult-to-digest oligosaccharide, difficult-to-digest protein, etc.; (6) animal polysaccharide such as chitin, chitosan, etc.; (7) synthetic polysaccharide such as polydextrose, etc.; (8) cellulose derivatives such as carboxy methyl cellulose, methyl cellulose, etc.; (9) polysaccharide of mushroom (edible fungi); (10) wheat bran, oats exodermis, corn exodermis, rice bran, barley bran, beet fiber, etc.; (11) anima protein such as gelatin, egg albumin, etc.

The above-described gelling agents have as common properties (1) gelling properties, (2) thickening and stabilizing properties; (3) moisture retention properties, (4) film-forming properties, (5) foam-uniformly dispersing properties, (6) crystal-generation prohibiting properties, (7) integrity, (8) improving and maintaining properties of quality of protein, (9) interactive properties between polysaccharides (improvement in the strength of gel), (10) improving properties of mouth sensation (texture) , etc.

The gelling agent most preferably used in the present invention is glucomannan. While the term “glucomannan” is also called as “purified powder of devil's tongue jelly (konnyaku)”, the term “glucomannan” is used uniformly in the present specification. Accordingly, the term “glucomannan” herein used includes the meaning of “purified powder of devil's tongue jelly (konnyaku)”. The glucomannan is contained in devil's tongue jelly (konnyaku) and is polysaccharide to which mannose and glucose are bonded by β 1-4 linkage and which has the molecular weight of 1000000 to 2000000. The molecule of glucomannan contains trace amounts of acetyl group, uronic acid residue, etc. other than mannose and glucose.

Glucomannan can be gelled irreversibly only by treating by alkaline as a gelling agent. When glucomannan is treated with alkaline, chemical structural change occurs in which an acetyl group bonded as an ester-linkage is eliminated. That is to say, an elimination of acetyl group is indispensable reaction for gelation of glucominant and a basic measure of completion of gelation.

The minimum concentration of water-solution of glucomannan, which can be gelled by an alkaline-treatment, is about 0.5%, at which concentration 100% of acetyl group is eliminated. When the concentration of water-solution of glucomannan is 8% and above, only 0.5% of acetyl group is eliminated.

Accordingly, when glucomannan is used as a gelling agent in the present invention, the concentration of water-solution of glucomannan is preferably 0.5 to 8%. The concentration of 0.5% and below or 8% and above is not preferable, because 100% of water-solution of glucomannan is not gelled. Further, the concentration of water-solution of glucomannan is preferably 1.5 to 8% from the viewpoint of practicability of handling as elastic gel. Furthermore, the concentration of water-solution of glucomannan is preferably 2 to 8% from the viewpoint that the amount of extrusion from gel is decreased.

Next, the phenomenon of the extrusion of water from gel is described. When a glucomannan gel is allowed to stand, the glucomannan gel extrudes water from the gel and shrinks. The causes of the extrusion of water from glucomannan gel are the concentration of glucomannan (concentration of purified powder of glucomannan), temperature of gelation, kinds and concentration of coagulating agent, storing temperature and storing term of gel, etc.

Since the free movement of water in gel is strongly restricted with increasing the concentration of the water solution of glucomannan within 2 to 8%, the amount of the extrusion of water from glucomannan gel decreases. Therefore, the concentration of water-solution of glucomannan is preferably 2 to 8% from the viewpoint that the amount of the extrusion of water from glucomannan gel is decreased.

The amount of the extrusion of water from glucomannan gel decreases by 17 to 18% with increasing the temperature of gelation within the range of 40 to 90° C. This is because that the rate of deacetylation increases and the structure of gel is rapidly stabilized.

The amount of the extrusion of water from glucomannan gel is not so affected by kinds and amount of a coagulating agent, that is alkaline compounds, but rather affected by pH at the time of gelation. The amount of the extrusion of water from glucomannan gel decreases linearly by 17 to 18% with increasing the pH within the range of pH. 10 to 12. The amount of the extrusion of water from glucomannan gel is when the pH is 12 and above.

The amount of the extrusion of water from glucomannan gel within the period of storage of gel is extremely large immediately after preparation, but decreases with the elapse of time, and stops after 14 days from preparation. The amount of the extrusion of water from glucomannan gel within the period of storage of gel increases with increasing the storing temperature within the range of 3 to 40° C.

Next, glucomannan is described from the view point of nutritional science is described from the viewpoint of nutritional science. Standard components of the glucomannan are shown in

TABLE 4

| In 100 g of glucomannan | |
|---|---|
| Calorie (kcal) | 5 |
| Water contents (g) | 97.3 |
| Protein (g) | 0.1 |
| Lipid (g) | 0 |
| Carbohydrate (g) | 2.3 |
| Ash content (g) | 0.3 |
| Sodium (mg) | 10 |
| Potassium (mg) | 60 |
| Calcium (mg) | 43 |
| Magnesium (mg) | 3 |
| Phosphorus (mg) | 5 |
| Iron (mg) | 0.4 |
| Zinc (mg) | 7.0 |
| Cupper (mg) | 2.8 |
| Vitamin A, D, E, K, B1, B2, | 0 |
| B12, C, niacin, pantothenic | |
| acid (mg) | |
| Vitamin B6 (mg) | — |
| Folic acid (g) | — |
| Fatty acid (g) | — |
| Total amount of dietary fiber (g) | 2.2 |

It is evident as shown in Table-4 that glucomannan contains large amounts of potassium, calcium and dietary fiber. Calcium contained in glucomannan dissolves well in acid and therefore dissolves easily in a stomach and is adsorbed from a small intestine. Dietary fibers contained an glucomannan are water-soluble and have effects of; (1) improvement in the balance of enteric gram negative bacilli, (2) excretion of sodium by virtue of ion exchange action from contents in intestine, (3) excretion of injurious substances in intestine by increasing the amount of faces, and (4) inhibition of excess adsorption of cholesterol and sugar.

A yam, Chinese yam, taro, lotus root, egg, etc. may be optionally added as a thickening liaison to the composition for soybean-processed food of the present invention. A viscous substance contained in a yam comprises a glycoprotein formed by bonding a protein containing mucin as a main component with mannan. The viscosity of a yam increases when a yam raw is grated.

The composition for soybean-processed food of the present invention comprises 5 to 10% of the above-described soybean protein, 0.5 to 8% of gelling agent, 0.1 to 0.3% of coagulating agent and 70 to 90% of water on the basis of the total weight of the composition.

5% and below or 10% and above of the soybean protein in the composition for a soybean protein-processed food of the present invention is not preferable. This is because that when the composition for a soybean protein-processed food of the present invention containing the soybean protein in such an amount is processed to prepare a hamburger steak, a croquette, a meat-ball, a meat-sauce, etc. containing no meat, the “coagulating properties” “viscosity” “elasticity” and “stickiness” which are important as texture profile of food can not be obtained.

0.5% and below or 8% and above of the gelling agent in the composition for a soybean protein-processed food of the present invention is not preferable. This is because that all the composition for a soybean protein-processed food of the present invention cannot be necessarily gelled.

When the amount of coagulating agent is 0.1% a nd below in the composition for a soybean protein-processed food of the present invention, the coagulating rate is low. When the amount of coagulating agent is 0.3% and above in the composition for a soybean protein-processed food of the present invention, it is excessive amount and increases cost.

When the composition for a soybean protein-processed food of the present invention in itself is processed to prepare a hamburger steak, a croquette, a meat-ball, a meat-sauce, etc. containing no meat or is used as a bulking agent or quality modifier for a meat processed-food such as a hamburger steak, a croquette, a meat-ball, a meat-sauce, etc., particle-like soybean proteins and fiber-like soybean proteins are preferably used.

As a gelling agent used in the composition for a soybean protein-processed food of the present invention glucomannan is most preferably used. This is because that (1) glucomannan is the most excellent gelling function; (2) a large amount of dietary fibers; can be ingested; and (3) the “coagulating properties” “viscosity” “elasticity” and “stickiness” which are important as texture profile of food can be improved.

When glucomannan is used as a gelling agent in the composition for a soybean protein-processed food of the present invention, sodium hydroxide or calcium hydroxide may be use as an alkaline compound for a coagulating agent.

The composition for a soybean protein-processed food of the present invention can be processed, in itself to prepare a hamburger steak, a croquette, a meat-ball, a meat-sauce, etc. containing no meat or can be used as a bulking agent or quality modifier for a meat processed-food such as a hamburger steak, a croquette, a meat-ball, a meat-sauce, etc. However, texture or mouth sensation can be further improved by adding edible fats and fatty oils into the composition for a soybean protein-processed food of the present invention.

Paste of a meat-containing or meat-not-containing processed food of the present invention comprises 5 to 10% of soybean protein, 0.5 to 8% of gelling agent, 0.1 to 0.3% of coagulating agent, 0.1 to 1% of edible fats and fatty oils and 70 to 90% of water on the basis of the total weight of the paste.

The edible fats and fatty oils are classified into edible fatty oils and edible fats. Preferable examples of the edible fatty oils are soybean oil, rapeseed oil, rice bran oil, safflower oil, sunflower oil, sesame oil, corn oil, peanut oil, kapok oil, etc. Preferable examples of vegetable edible fats are coconut oil, palm oil, cocoa butter, mango oil, etc. Preferable examples of animal edible fats are lard, vet, butter, etc. Preferable examples of processed fat are shortening, margarine, etc.

Vegetable oil containing 80 to 90% of unsaturated fatty acid may be preferably used in the present invention. An unsaturated fatty acid contains an essential fatty acid (vitamin F) which is necessary for heart, circulatory system and skin, but is not produced in vivo such as Ω-3-(linoleic acid), Ω-6-(linolenic acid), arachidonic acid, etc. An unsaturated fatty acid has a low melting point and can be well adsorbed from an alimentary canal and is effective for treatment and prevention of hyperlipemia.

Since the contents of higher fatty acid contained in soybean oil or safflower oil usually used for deep-fried foods are high, it has a defect that it is easy to be oxidized. Recently, a low-linolenic acid-containing soybean oil, high-oleic acid-containing olive oil, high-oleic acid-containing sunflower oil, high-oleic acid-containing safflower oil, etc. have been produced by genetic study of seeds. While a conventional rapeseed oil contains a large amount of erucic acid which causes heart failure, a low-erucic acid-containing rapeseed oil has been developed which contains 5% and below of erucic acid. It is, therefore, preferable to use such a new developed vegetable oil in the present invention.

The paste for a meat-containing or meat-not-containing processed food of the present invention can be processed in itself to prepare a hamburger steak, a croquette, a meat-ball, a meat-sauce, etc. containing no meat which can be eaten. Alternatively, when the paste for a meat-containing or meat-not-containing processed food of the present invention is added as a bulking agent or quality modifier into meat to prepare a hamburger steak, a croquette, a meat-ball, a meat-sauce, etc. containing meat, a portion of meat is substituted for such paste, and simultaneously the same nutritional value (nitrogen equilibrium) and digestion ration as those obtained when the entire amount of meat is ingested can be obtained.

Glucomannan is most preferably used as a gelling agent used in the paste for a meat containing or meat-not-containing processed food of the present invention. This is because that (1) glucomannan is the most excellent gelling function; (2) a large amount of dietary fibers can be ingested; and (3) the “coagulating properties” “viscosity” “elasticity” and “stickiness” which are important as texture profile of food can be improved.

When glucomannan is used as a gelling agent in the paste for a meat-containing or meat-not-containing processed food of the present invention, sodium hydroxide, calcium hydroxide or potassium hydroxide may be use as an alkaline compound for a coagulating agent.

Imitation seasoned dried meat can be produce by exposing the paste for a meat-containing or meat-not-containing processed food of the present invention to smoke. In this case, a cold smoking method, hot smoking method and high temperature-smoking method can be used as a smoking method. In a case of a cold smoking method, an imitation dried sausage can be produced by exposing the paste for a meat-containing or meat-not-containing processed food of the present invention to smoke at temperatures of 40° C. and below for about 5 hours and adding 7 to 15% of salt. The imitation dried sausage thus produced has the water contents of 30 to60% and is stiff and tough. In a case of a hot smoking method, an imitation soft ham or bacon can be produced by exposing the paste for a meat-containing or meat-not-containing processed food of the present invention to smoke at temperatures of 70 to 80° C. for 4 to 5 hours and adding 7 to 15% of salt, if necessary. The imitation soft ham or bacon thus produced has the water contents of 60 to 70% and is soft and flexible.

Imitation pemmican can be produced from the composition for soybean-processed food of the present invention by a similar method to that for preparing real pemmican. That is to say, imitation pemmican can be produced by dipping the composition for soybean processed food of the present invention into a seasoning solution containing spice and salt, if necessary, at temperatures of 0 to 5° C., freezing, defrosting, roasting to decrease the water-contents to 50%, aging for 30-60 minutes, cutting into rectangles, and then drying at temperatures of 80° C, and below to obtain desired water-contents. As a drying method a pressure-reducing drying method or microwave drying method is used.

Into the composition for soybean processed food of the present invention or the paste for a meat-containing or meat-not-containing processed food of the present invention, various kinds of food additives such as a seasoning, flavor, preservative, coloring agent, spice, etc. usually used legally in the field of food may be added.

### MEANS FOR SOLVING THE PROBLEMS

The afore-mentioned problems can be solved by the means described below:

1. A composition for preparing soybean protein-processed food which comprises a soybean protein, a gelling agent, a coagulating agent and is gelled by heating, wherein said a soybean protein is selected from the group consisting of soybean milk, dried soybean milk, soybean protein curd, particle-like separated soybean protein, particle-like concentrated soybean protein, spun fiber-like soybean protein, structural fiber-like soybean protein, particle-like soybean protein, hunk-like soybean protein, flake-like soybean protein, bar-like soybean protein and dice-like soybean protein.

2. In the above-described Item 1, said composition comprises 5 to 10% of the soybean protein, 0.5 to 8% of the gelling agent, 0.1 to 0.3% of the coagulating agent and 70 to 90% of water on the basis of the total weight of the composition.

3. In the above-described Item 1 or 2, the gelling agent is selected from the group consisting of; a polysaccharide or lignin originating from a constituent of plant cell wall; plant gum; a water-soluble polysaccharide originating from a seed; a water-soluble polysaccharide originating from a rhizome; a water-soluble polysaccharide originating from sap; seaweed polysaccharide; polysaccharide originating from microorganisms; difficult-to-digest starch; difficult-to-digest dextrin; difficult-to-digest oligosaccharide; difficult-to-digest protein; animal polysaccharide; synthetic polysaccharide; polysaccharide originating from mushroom; grain fibers; and anima protein.

4. In the above-described Item 3, the water-soluble polysaccharide originating from a rhizome is glucomannan.

5. A paste for a meat-containing or meat-not-containing processed food comprising the composition for preparing soybean protein-processed food described in Item 1 and edible fat and fatty oil added therein.

6. In the above-described Item 5, said paste comprises 5 to 10% of a soybean protein, 0.5 to 8% of a gelling agent, 0.1 to 0.3% of a coagulating agent and 70 to 90% of water on the basis of the total weight of the paste.

7. In the above-described Item 5 or 6, the gelling agent is selected from the group consisting of; a polysaccharide or lignin originating from a constituent of plant cell wall; plant gum; a water-soluble polysaccharide originating from a seed; a water-soluble polysaccharide originating from a rhizome; a water-soluble polysaccharide originating from sap; seaweed polysaccharide; polysaccharide originating from microorganisms; difficult-to-digest starch; difficult-to-digest dextrin; difficult-to-digest oligosaccharide; difficult-to-digest protein; animal polysaccharide; synthetic polysaccharide; polysaccharide originating from mushroom; grain fibers; and anima protein.

8. In the above-described Item 7, the water-soluble polysaccharide originating from a rhizome is glucomannan.

9. In any one of the above-described Items 5 to 8, the edible fat and fatty oil is a vegetable fat and fatty oil containing a large amount of unsaturated fatty acid.

10. In the above-described Item 9, the vegetable fat is selected from the group consisting of high-oleic acid-containing sunflower oil, high-oleic acid-containing safflower oil and low-erucic acid-containing rapeseed oil.

11. An imitation pemmican produced by a method comprising steps; dipping the composition for soybean processed food described in any one in the above-described Items 1 to 4 into a seasoning solution containing spice and salt, if necessary; freezing; defrosting; roasting to decrease the water-contents to 50%; drying at temperatures of 80° C. to obtain predetermined water-contents; and cutting into rectangles.

12. An imitation dried sausage produced by a method comprising steps; dredging the paste for a meat-containing or meat-not-containing processed food described in any one of the above-described Items 5 to 10 with a salt or spice, if necessary; and exposing to smoke to decrease the water contents to 30 to 60%.

13. An imitation ham or bacon produced by a method comprising steps; adding milk protein, cornstarch, wheat flour, breadcrumbs, yeast essence, if necessary into the paste for a meat-containing or meat-not-containing processed food described in any one of the above-described Items 5 to 10; and exposing it to smoke if necessary to decrease the water contents to 60 to 70%.

### EFFECT OF THE INVENTION

Such effects as described below can be obtained by the invention described in claim 1:

1. By the use of soybean protein as a main component, an insulin action reinforcing effect, an estrogen action effect, an antihypertensive action, a cholesterol-lowering effect, a biological controlling action such as antithrombotic action, a metabolic activation effect (triglyceride synthetase-lowering effect, serum lipid concentration-lowering effect, serum cholesterol-lowering effect), an anti-oxidant effect, a physiological function such as glycolipid metabolic activation, a intestinal controlling function, etc. are expected.

2. Since a soybean protein is selected from the group consisting of soybean milk, dried soybean milk, soybean protein curd, particle-like separated soybean protein, particle-like concentrated soybean protein, spun fiber-like soybean protein, structural fiber-like soybean protein, particle-like soybean protein, hunk-like soybean protein, flake-like soybean protein, bar-like soybean protein and dice-like soybean protein, almost all of the soybean protein produced now in Japan may be used. Thereby, the optimum soybean protein may be selected according to kinds, forms, textures, taste, color, appearance, flavor, etc. of a product to be produced.

3. By the use of soybean protein instead of meat, the nitrogen-equilibrium and digestion rate do not change.

4. Since a water solution of soybean proteins as a main component of the composition of the present invention is gelled by a gelling agent, the following effects can be obtained: elasticity and viscosity of the gelled soybean proteins are drastically increased; Newton's viscosity of the gelled soybean proteins changes to non-Newton's viscosity; the gelled soybean proteins have a yield point; and the gelled soybean proteins are easy to chew; the gelled soybean proteins are not too soft and not too hard, and have the improved elasticity and viscosity and chewy mouth sensation similar to that which is obtained when chewing meat.

5. Since the composition of the present invention comprises a soybean protein as an indispensable component, a gelling agent, a coagulating agent and water, the composition of the present invention is an object of a commercial transaction.

According to the invention described in claim 2, the rate of the gelling agent, coagulating agent to water is within the optimum range for gelation. Therefore, 100% of the composition can be gelled.

According to the invention described in claim 3, the gelling agent is selected from the group consisting of; a polysaccharide or lignin originating from a constituent of plant cell wall; plant gum; a water-soluble polysaccharide originating from a seed; a water-soluble polysaccharide originating from a rhizome; a water-soluble polysaccharide originating from sap; seaweed polysaccharide; polysaccharide originating from microorganisms; difficult-to-digest starch; difficult-to-digest dextrin; difficult-to-digest oligosaccharide; difficult-to-digest protein; animal polysaccharide; synthetic polysaccharide; polysaccharide originating from mushroom; grain fibers; and anima protein. Therefore, the gelling properties, bonding properties and stability, moisture-retention, integrity, improvement and maintain of the quality of protein, interactive action between polysaccharides (improvement in strength of gel), improvement in mouth sensation (texture), etc. can be given to a food. Simultaneously, large amounts of dietary fibers can be ingested.

According to the invention described in claim 4, glucomannan originating from a rhizome is used as a gelling agent. A water solution of the composition of the present invention is completely gelled and the gelling properties, bonding properties and stability, moisture-retention, integrity, improvement and maintain of the quality of protein, interactive action between polysaccharides (improvement in strength of gel), improvement in mouth sensation (texture), etc. can be given to a food. Simultaneously, large amounts of dietary fibers can be ingested. A calcium component dissolved in glucomannan is easy to be dissolved in a stomach and adsorbed from a small intestine. Dietary fibers contained in glucomannan are water-soluble and have effects of; (1) improvement in the balance of enteric gram negative bacilli, (2) excretion of sodium by virtue of ion exchange action from contents in intestine, (3) excretion of injurious substances in intestine by increasing the amount of faces, and (4) inhibition of excess adsorption of cholesterol and sugar.

The paste for a meat-containing or meat-not-containing processed food described in claim 5 can be processed in itself to prepare a hamburger steak, a croquette, a meat-ball, a meat-sauce, etc. containing no meat which can be eaten. Alternatively, when the paste for a meat-containing or meat-not-containing processed food described in claim 5 is added as a bulking agent or quality modifier into meat to prepare a hamburger steak, a croquette, a meat-ball, a meat-sauce, etc. containing meat, a portion of meat is substituted for such paste, and simultaneously the same nutritional value (nitrogen equilibrium) and digestion ration as those obtained when the entire amount of meat is ingested can be obtained.

According to the invention described in claim 6, the rate of the gelling agent, coagulating agent to water is within the optimum range for gelation. Therefore, 100% of the paste can be gelled.

According to the invention described in claim 7, the gelling agent is selected from the group consisting of; a polysaccharide or lignin originating from a constituent of plant cell wall; plant gum; a water-soluble polysaccharide originating from a seed; a water-soluble polysaccharide originating from a rhizome; a water-soluble polysaccharide originating from sap; seaweed polysaccharide; polysaccharide originating from microorganisms; difficult-to-digest starch; difficult-to-digest dextrin; difficult-to-digest oligosaccharide; difficult-to-digest protein; animal polysaccharide; synthetic polysaccharide; polysaccharide originating from mushroom; grain fibers; and anima protein. Therefore, the gelling properties, bonding properties and stability, moisture-retention, integrity, improvement and maintain of the quality of protein, interactive action between polysaccharides (improvement in strength of gel), improvement in mouth sensation (texture), etc. can be given to a food. Simultaneously, large amounts of dietary fibers can be ingested.

According to the invention described in claim 8, glucomannan originating from a rhizome is used as a gelling agent. A water solution of the composition of the present invention is completely gelled and the gelling properties, bonding properties and stability, moisture-retention, integrity, improvement and maintain of the quality of protein, interactive action between polysaccharides (improvement in strength of gel), improvement in mouth sensation (texture), etc. can be given to a food. Simultaneously, large amounts of dietary fibers can be ingested. A calcium component dissolved in glucomannan is easy to be dissolved in a stomach and adsorbed from a small intestine. Dietary fibers contained in glucomannan are water-soluble and have effects of; (1) improvement in the balance of enteric gram negative bacilli, (2) excretion of sodium by virtue of ion exchange action from contents in intestine, (3) excretion of injurious substances in intestine by increasing the amount of faces, and (4) inhibition of excess adsorption of cholesterol and sugar.

According to the invention described in claim 9, vegetable oil containing 80 to 90% of unsaturated fatty acid can be used. Therefore, an unsaturated fatty acid containing an essential fatty acid (vitamin F) which is necessary for heart, circulatory system and skin, but is not produced in vivo such as Ω-3-(linoleic acid), Ω-6-(linolenic acid), arachidonic acid, etc. can be ingested. An unsaturated fatty acid has a low melting point and can be well adsorbed from an alimentary canal and is effective for treatment and prevention of hyperlipemia.

According to the invention described in claim 10, the vegetable fat is selected from the group consisting of high-oleic acid-containing sunflower oil, high-oleic acid-containing safflower oil and low- erucic acid-containing rapeseed oil. Since the contents of higher fatty acid contained in soybean oil or safflower oil usually used for deep-fried foods are high, it has a defect that it is easy to be oxidized. However, such a low-linolenic acid-containing soybean oil, high-oleic acid-containing olive oil, high-oleic acid-containing sunflower oil or high-oleic acid-containing safflower oil as described in claim 10 has no defects, which cause heart failure, etc.

According to the invention described in claim 11, imitation pemmican is produced by the composition for soybean-processed food described in any one of claims 1 to 4. Such imitation pemmican contains no beef, has good storage properties and is available for a carrying preserving food. Such imitation pemmican resembles beef jerky (trade mark), which can be eaten by both a man and an animal.

According to the invention described in claim 12, an imitation dried sausage is produced from the paste for a meat containing or meat-not-containing processed food described in any one of claims 5 to 10. Such an imitation dried sausage contains no beef, has good storage properties and is available for a carrying preserving food.

According to the invention described in claim 13, an imitation ham or bacon is produced from the paste for a meat containing or meat-not-containing processed food described in any one of claims 5 to 10. Such an imitation ham or bacon contains no pork, has good storage properties and is available for a carrying preserving food.

### MOST PREFFERED EMBODIMENT FOR CARRYING OUT INVENTION

Most embodiments for carrying out the invention will be described below with reference to examples.

### EXAMPLE 1

[Production of a Composition for Preparing a Soybean Protein Processed Food]

Step 1: A water solution of calcium was previously prepared by dissolving 2 g of calcium hydroxide as a coagulating agent in 80 c of hot water having a temperature of 60° C.

Step 2: Independently from the Step 1, a water solution of soybean protein was prepared by adding 50 g of fibrous soybean protein manufactured by AJINOMOT CO. LTD. under the trade mark “PROTEX FA” into 150 cc of hot water having a temperature of 60° C. The water solution of soy bean protein thus obtained was vigorously stirred and 10 g of dried egg as binding agent were added thereto, and stirred, then was added the water solution of calcium prepared in the Step 1, and vigorously stirred.

Step 3: A water solution of a gelling agent was prepared by adding 30 g of glucomannan into 678 cc of hot water having a temperature of 60° C. and vigorously stirred to form a jelly-like product. To the jelly-like product was added a water solution comprising soybean protein, dried egg and calcium hydroxide prepared in the Step 2 and vigorously kneaded.

Sensory Test-Routine Test

Each of 50 members of panelist having analyzing abilities was isolate. Smoking, gum and lipstick were prohibited within 30 minutes before the test. Lighting, room temperatures and air ventilation in each of testing rooms were under the same conditions, respectively.

For each of a hamburger steak containing no beef prepared in example 1 and a real hamburger steak containing beef, a visual inspection test for checking an appearance and a taste-flavor test were made for 50 members of panelists, All members of panelists could not distinguish the both from each other.

Triangular System

50 of hamburger steaks containing beef were prepared as reference standards. Example 1 was repeated 100 times to prepare 100 of the same samples. One reference standard and two samples were given to each of 50 panelists, and sensory tests were carried out by a method of triangular system. In this case, the eating order was random in consideration of effect by order; center and both ends were exchanged in consideration of effect by position; a more than 2-digit number was given to reference standards and samples in consideration of effect by mark. When 50 members of panelist were made to point a reference standard, The rate of correct answers of 50 members of panelist was 1/9.

Sensory Test-Taste Inspection

The same 50 members of panelist as those who carried out the routine test were prepared. 50 of hamburger steaks containing beef were prepared as reference standards. Example 1 was repeated 150 times to prepare 150 of the same samples. One reference standard and three samples were given to each of 50 panelists. In a marking method, the order of taste (liking) was separated into 3, 6 and 9 steps. An average point and dispersions were obtained. As a result a statistical analysis, no significant difference in taste was observed between one reference standard and three samples for 50 panelists.

### EXAMPLE 2

[Production of a Paste for Preparing a Meat Containing or Meat-Not Containing Processed Food]

A paste for preparing a meat containing or meat-not containing processed food was prepared by adding 8 g high-oleic acid-containing safflower oil to the composition for preparing a soybean protein processed food prepared in Example 1. The composition of high-oleic acid-containing safflower oil has 85.1 of iodine value and 191.9 of saponification value and comprises 5.1% of palmitic acid, 2.3% of stearic acid, 76.8% of oleic acid, 14.7% of linoleic acid, 7.5% of total saturated fatty acid and 91.5% of total unsaturated fatty acid.

A hamburger steak containing no beef was prepared by the use of the paste prepared in Example 2. For comparison, a hamburger steak was prepared by substituting a half potion of beef for the paste prepared in Example 2, which was used as a quasi-reference standard. A real hamburger steak was prepared, which was used as a reference standard.

Sensory Test-Routine Test

Each of 50 members of panelist having analyzing abilities was isolate. Smoking, gum and lipstick were prohibited within 30 minutes before the test. Lighting, room temperatures and air ventilation in each of testing rooms were under the same conditions, respectively.

For a hamburger steak containing no beef prepared in Example 2, the above-described quasi-reference standard and the above-described reference standard, a visual inspection test for checking an appearance and a taste-flavor test were made for 50 members of panelists. All members of panelists could not distinguish three samples from each other.

Triangular System Test-1

50 of hamburger steaks containing beef were prepared as a quasi-reference standard in which a half portion of beef was substituted for the paste prepared in Example 2. Example 2 was repeated 100 times to prepare 100 of the same samples. One quasi-reference standard and two samples were given to each of 50 panelists, and sensory tests were carried out by a method of triangular system. In this case, the eating order was random in consideration of effect by order; center and both ends were exchanged in consideration of effect by position; a more than 2-digit number was given to reference standards and samples in consideration of effect by mark. When 50 members of panelist were made to point a reference standard, the rate of correct answers of 50 members of panelist was 1/9.

Triangular System Test-2

50 of real hamburger steaks containing beef were prepared as a reference standard in which total amount of beef was used. Example 2 was repeated 100 times to prepare 100 of the same samples. One reference standard and two samples were given to each of 50 panelists, and sensory tests were carried out by a method of triangular system-test. In this case, the eating order was random in consideration of effect by order; center and both ends were exchanged in consideration of effect by position; a more than 2-digit number was given to reference standards and samples in consideration of effect by mark. When 50 members of panelist were made to point a reference standard, the rate of correct answers of 50 members of panelist was 1/9.

Sensory Test-Taste Inspection

The same 50 members of panelist as those who carried out the routine test were prepared. 50 of hamburger steaks containing beef were prepared as reference standards. Example 2 was repeated 150 times to prepare 150 of the same samples. One reference standard and three samples were given to each of 50 panelists. In a marking method, the order of taste (liking) was separated into 3, 6 and 9 steps. An average point and dispersions were obtained. As a result a statistical analysis, no significant difference in taste was observed between one reference standard and three samples for 50 panelists.

### EXAMPLE 3

Imitation pemmican was produced by dipping the composition for soybean processed food prepared in Example 1 in to a seasoning solution containing spices and salts at temperatures of 0 to 5° C., freezing, defrosting, roasting for 30 minutes to decrease the water-contents to 50% and below, aging for 30-60 minutes, drying under vacuum of 30 Torr at a temperature of 60° C. to set at a given water contents, and cutting into rectangles by pressuring.

### EXAMPLE 4

Imitation dried sausage was produced by dredging the paste for a meat-containing or meat-not-containing processed food prepared in Example 2 with salt and spice, and exposing it to smoke at temperatures of 40° C. and below for 5 days to a prepare dried sausage having 7% of salt concentration and 45% of water contents.

### EXAMPLE 5

Imitation ham was produced by preserving the paste for a meat-containing or meat-not-containing processed food prepared in Example 2 in salt, washing, drying and exposing it to smoke at temperatures of 70 to 80° C. for 4 to 5 hours to prepare imitation ham having 4% of salt concentration and 50% of water content.

### INDUSTRIAL APPLICABILITY

The present invention has an industrial applicability as described below:

(1) Since the present invention uses soybean protein as a main component, such effects as describe below can be obtained:

(A) By the use of soybean protein as a main component, an insulin action reinforcing effect, an estrogen action effect, an antihypertensive action, a cholesterol-lowering effect, a biological controlling action such as antithrombotic action, a metabolic activation effect (triglyceride synthetase-lowering effect, serum lipid concentration-lowering effect, serum cholesterol-lowering effect), an anti-oxidant effect, a physiological function such as glycolipid metabolic activation, a intestinal controlling function, etc. are expected.

(B) Since a soybean protein is selected from the group consisting of soybean milk, dried soybean milk, soybean protein curd, particle-like separated soybean protein, particle-like concentrated soybean protein, spun fiber-like soybean protein, structural fiber-like soybean protein, particle-like soybean protein, hunk-like soybean protein, flake-like soybean protein, bar-like soybean protein and dice-like soybean protein, almost all of the soybean protein produced now in Japan may be used. Thereby, the optimum soybean protein may be selected according to kinds, forms, textures, taste, color, appearance, flavor, etc. of a product to be produced.

(C) By the use of soybean protein instead of meat, the nitrogen-equilibrium and digestion rate do not change.

(D) Since a water solution of soybean proteins as a main component of the composition of the present invention is gelled by a gelling agent, the following effects can be obtained: elasticity and viscosity of the gelled soybean proteins are drastically increased; Newton's viscosity of the gelled soybean proteins changes to non- Newton's viscosity; the gelled soybean proteins have a yield point; and the gelled soybean proteins are easy to chew; the gelled soybean proteins are not too soft and not too hard, and have the improved elasticity and viscosity and chewy mouth sensation similar to that which is obtained when chewing meat.

(E) Since the composition of the present invention comprises a soybean protein as an indispensable component, a gelling agent, a coagulating agent and water, the composition of the present invention is an object of a commercial transaction. By virtue of the above-described main effects, it is practically feasible to develop new food business.

The use of bean-curd tofu refuse (okara) has been conventionally limited. However, bean-curd tofu refuse (okara) is used as soybean protein according to the present invention. Therefore, new use of bean-curd tofu refuse (okara) can be expanded on a commercial scale on the basis of scientific background.

Since glucomannan originating from devil's tongue jelly is used as a gelling agent, new use of devil's tongue jelly which is a traditional food material having been used for 1500 years can be expanded on a commercial scale on the basis of scientific background.

By using the present invention as a substitute for a meat processed food or by substituting the present invention for a part of meat, it is possible to decrease directly the amount of ingestion of meat and to contribute the prevention of various kinds of life-style related disease.

1. A composition for preparing a soybean protein-processed food which comprises a soybean protein, a gelling agent a coagulating agent and is gelled by heating. wherein said soybean protein is selected from the group consisting of soybean milk, dried soybean milk, soybean protein curd, particle-like separated soybean protein, particle-like concentrated soybean protein, spun fiber-like soybean protein, structural fiber-like soybean protein, particle-like soybean protein, amp hunk-like soybean protein, flake-like soybean protein, bar-like soybean protein and dice-like soybean protein.

2. A composition for preparing soybean protein-processed food according to claim 1, wherein the soybean protein is 5 to 10%, the gelling agent is 0.5 to 8%, the coagulating agent is 0.1 to 0.3% and water is 70 to 90% on the basis of the total weight of the composition.

3. A composition for preparing soybean protein-processed food according to claim 1, wherein the gelling agent is selected from the group consisting of; a polysaccharide or lignin originating from a constituent of plant cell wall; plant gum; a water-soluble polysaccharide originating from a seed; a water-soluble polysaccharide from a rhizome; a water-soluble polysaccharide originating from sap; seaweed polysaccharide; polysaccharide originating from microorganisms; difficult-to-digest starch; difficult-to-digest dextrin; difficult-to-digest oligosaccharide; difficult-to-digest protein; animal polysaccharide; synthetic polysaccharide; polysaccharide originating from mushroom; grain fibers; and anima protein.

4. A composition for preparing soybean protein processed food according to claim 3, wherein the water-soluble polysaccharide originating from a rhizome is glucomannan.

5. A paste for a meat-containing or meat-not-containing processed food comprising the composition for preparing soybean protein-processed food according to claim 1 and edible fat and fatty oil is added therein.

6. A paste for a meat-containing or meat-not-containing processed food according to claim 5, wherein a soybean protein is 0.5 to 8%, a gelling agent is 0.1 to 0.3%. a coagulating agent is 0.1 to 0.3%. an edible fat and fatty oil is 0.1 to 1% and water is 70 to 90% on the basis of the total weight of the paste.

7. A paste for a meat-containing or meat-not-containing processed food according to claim 5, wherein the gelling agent is selected from the group consisting of; a polysaccharide or lignin originating from a constituent of plant cell wall; plant gum; a water-soluble polysaccharide originating from a seed; a water-soluble polysaccharide originating from a rhizome; a water-soluble polysaccharide originating from sap; seaweed polysaccharide; polysaccharide originating from microorganisms; difficult-to-digest starch; difficult-to-digest dextrin; difficult-to-digest oligosaccharide; difficult-to-digest protein; animal polysaccharide; synthetic polysaccharide; polysaccharide originating from mushroom; grain fibers; and anima protein.

8. A paste for a meat-containing or meat-not-containing processed food according to claim 7, wherein the water-soluble polysaccharide originating from a rhizome is glucomannan.

9. A paste for a meat-containing or meat-not-containing processed food according to claims 5, wherein the edible fat and fatty oil is a vegetable fat and fatty oil containing a large amount of unsaturated fatty acid.

10. A paste for a meat-containing or meat-not-containing processed food according to claim 9, wherein the vegetable fat is selected from the group consisting of high-oleic acid-containing sunflower oil, high -oleic acid -containing safflower oil and low-erucic acid-containing rapeseed oil.

11. An imitation pemmican produced by a method comprising steps; dipping the composition for soybean processed food described in claim 1 into a seasoning solution containing spice and salt, if necessary; freezing; defrosting; roasting to decrease the water-contents to 50%; drying at temperatures of 80° C. to obtain predetermined water-contents; and cutting into rectangles.

12. An imitation dried sausage produced by a method comprising steps; dredging the paste for a meat containing or meat-not-containing processed food according to claim 5 with a salt or spice, if necessary; and exposing to smoke to decrease the water contents to 30 to 60%.

13. An imitation ham or bacon produced by a method comprising steps; adding milk protein, cornstarch, wheat flour, breadcrumbs, yeast essence, if necessary into the paste for a meat-containing or meat-not-containing processed food according to claim 5; and exposing it to smoke if necessary to decrease the water contents to 60 to 70%.
